(19) United States
(12) Patent Application Publication
(10) Pub. No.: US 2005/0034618 A1
(43) Pub. Date: Feb. 17, 2005

(54) Endless printing sleeve, of multi-layer type, which has a printing layer, a compressible layer and a circumferential stiffening layer

(75) Inventors: Philippe Barre, Riedisheim (FR); Helene Biava, Mulhouse (FR); Jean-Philippe Jenny, Hattstatt (FR); Yves Lemble, Lauw (FR); Gerard Rich, Orschwihr (FR)

Correspondence Address: LEYDIG VOIT & MAYER, LTD, 700 THIRTEENTH ST. NW, SUITE 300, WASHINGTON, DC, 20005-3960, US

(73) Assignee: Macdermid Graphic Arts S.A.S., Steinbach (FR)

(21) Appl. No.: 10/686,777

(22) Filed: Oct. 17, 2003

(30) Foreign Application Priority Data
Aug. 12, 2003 (FR) 03 09 865

(51) Int. Cl. B41F 13/10

(52) U.S. Cl. 101/376

(57) ABSTRACT

A printing sleeve with multiple layers including a printing layer, a compressible layer, and a circumferential stiffening layer. The stiffening layer is located between the compressible layer and the printing layer.

The invention relates to an endless printing sleeve of the multi-layer type, which has a printing layer, a compressible layer and a circumferential stiffening layer.

Sleeves of this type are already known, which have a radially internal rigid layer, for example made of metal, an exterior printing layer and an intermediate compressible layer, arranged between the rigid internal layer and the printing layer.

These known sleeves have the major disadvantage of requiring a relatively complicated manufacturing process and of having a high cost.

The invention aims to palliate these disadvantages.

In order to reach this aim, the printing sleeve according to the invention is characterized by the fact that the compressible layer is the radially internal layer of the sleeve, and the stiffening layer is provided between the compressible layer and the printing layer.

According to one characteristic of the invention, on the radially internal surface of the compressible layer, the sleeve has a film for facilitating removal.

According to another characteristic of the invention, the circumferential stiffening layer is a reinforcing layer arranged on the compressible layer.

The invention will be better understood and other aims, characteristics, details and advantages of it will appear more clearly in the course of the following explanatory description given in reference to the appended drawings which are given as an example illustrating an embodiment of the invention and in which:

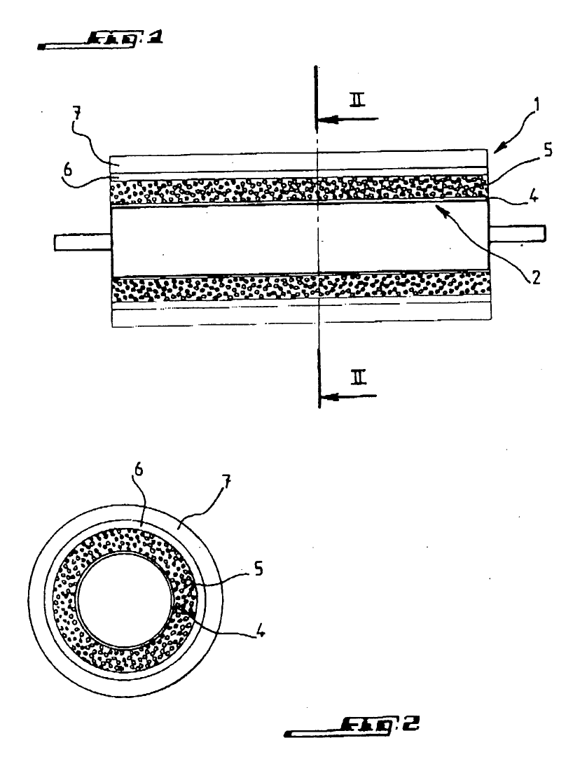

FIG. 1 is a view of the axial section of a printing sleeve according to the invention; and

FIG. 2 is a view of the radial section of the sleeve according to FIG. 1, according to line II-II.

FIGS. 1 and 2 illustrate the multi-layer structure 1 of a printing sleeve, mounted on support cylinder 2. The sleeve has film 4 for facilitating removal, compressible layer 5, reinforcing layer 6 and printing layer 7 successively and radially from the interior to the exterior.

The sleeve thus formed is produced on a tool tube of the type with a cushion of compressed air created by sending compressed air through holes in the peripheral surface of the tube. Different processes which can be used for this purpose are known and can be used in the context of the invention. After the production of the sleeve on the tube, it will be removed from the tube by slipping it off by creation of an air cushion between the internal surface of the sleeve and the external surface of the tube, and it is then fit over the support cylinder of a printing machine. The sleeve can be formed on one tube or on several tubes if required by the manufacturing process. This does not need to be described specifically since it is also part of the state of the art.

The novelty of the invention lies rather in the constitution of the different layers of the sleeve, which will be explained hereafter.

Removal facilitating film 4 formed directly on the sleeve must have very low roughness in order to promote the operations of slipping the sleeve off and on the tube and a support sleeve, but must have a higher friction coefficient than the metal of the tube or of the cylinder, or a covering film made of polyester or similar for limiting any creeping of the sleeve during functioning.

This film can be created during the manufacturing of the sleeve in the manner of a gel coat or a paint which is applied on the peripheral surface of the tube after a removal facilitating agent has been applied to this peripheral surface.

The film can also be formed by an elastomeric or plastic polymer, such as an endless molded film, in the form of a tube or endlessly joined during the molding. It could be a thermoplastic or not. The polymer could also be capable of being crosslinked by temperature or radiation.

The film could be in the form of a tube capable of heat-shrinking or in the form of a layer applied in the form of a powder by electrostatic and thermal projection.

Concerning the properties of the removal facilitating film, it advantageously has a modulus of 5 to 800 MPa, a thickness of 0.02 to 0.1 mm, a surface condition characterized by an Ra factor less than 0.5 microns and a friction coefficient on steel or on composite resin in the vicinity of 0.3 and preferably between 0.2 and 0.5. The removal facilitating film has a precise function during the production of the sleeve. It can be removed by an appropriate means such as machining before use of the sleeve in printing. It can also be completely absent without leaving the scope of the invention.

Compressible layer 5 is formed by a thermoplastic or thermosetting elastomer base containing expanded microspheres or microspheres which are to be expanded, if applicable, of two or more different sizes, open or closed, one or more expansion agents, in the presence of reinforcing fibers or not. This expansion can be thermal or not. Thermal expansion is necessary if the cells are introduced not expanded or if it is a matter of a swelling agent which decomposes thermally. A thermosetting base contains a crosslinking agent such as peroxide with or without co-agent or a sulfur/accelerator system acting during the expansion, if necessary, by adding a resin with an isocyanate or phenol or epoxy function. Layer 5 can be uniform in the form of one or more superposed under-layers of different compressibility.

The base can be placed on film 4 by coating, spraying or spray gunning after being put in solution in a solvent. It can be present in the form of a rolled or extruded sheet, and the layer can then be formed by rolling this sheet over itself or in a helicoidal strip so as to produce an endless layer. The expansion could then be triggered at an appropriate time after it is put in place.

Layer 5 could also be molded and calibrated in terms of thickness on removal facilitating film 4 or molded and then rectified after expansion. The compressible layer can be adjustable in terms of thickness and with regard to the compression modulus, by thermal post-treatment once the sleeve is formed, before mounting on the support cylinder of the printing arrangement.

Reinforcing layer 6, arranged over the compressible layer, is made of a composite material which has, in a thermoplastic or thermosetting polymer matrix, reinforcing elements in the form of fibers or wires helicoidally wound, a knit or weave or screen, arranged in one or more plies, preferably 2 or 3, according to a circular or helicoidal winding. The reinforcing elements are preferably made of carbon, glass, high modulus polyester, aramide. The reinforcing elements are present in composite layer 6 in a proportion between 20-80 wt % of the composite.

The thermoplastic or crosslinkable matrix is present in the layer in a proportion between 80-20 wt % of the composite. In the case of a matrix of the thermoplastic type, it is made of polyolefin or polyamide, or polyester or similar. A hardening or crosslinkable matrix is of the epoxy, polyurethane or acrylate or polyester type or a mixture of polyurethane epoxy with or without acrylate termination possibly including a plasticizer or flexibility agent and mineral charges. The crosslinking is brought about by temperature, with a hardener, or by radiation with a UV or EB photo-initiator in combination with multifunctional acrylate or methacrylate monomers. The Young's modulus of such a matrix is preferably between 50-1000 MPa.

It should be noted that the reinforcing elements such as fibers have a single directional arrangement in order to limit the elongation of the structure in the direction of rotation of the assembly. They are therefore oriented roughly circumferentially at least in the majority or mainly.

The reinforcing layer can be molded and calibrated or mounted and machined after hardening.

Concerning the properties of reinforcing composite layer 6, it has a thickness preferably between 0.2-0.5 mm and a Young's modulus in the circumferential direction between 400-100,000 MPa, and preferably between 1000-2000 MPa. The elongation at break in the circumferential direction is greater than 1.2% and preferably between 2-4%. The circumferential rigidity combined with the elasticity is necessary both for maintaining the strip of paper which is to be printed and for the register of colors and the immobilization on the cylinder once the sleeve is installed. The Young's modulus in the radial direction is between 50-500 MPa. The Young's modulus in the direction parallel to the axis of the cylinder is preferably greater than 100 MPa in order to facilitate handling and slipping on of the sleeve. The expert in the field will have understood that composite layer 6 will preferably have very anisotropic mechanical properties.

The layer can undergo a deviation between 100-500 microns without fracture. Concerning the force of cohesion with compressible layer 5, the peeling force is greater than 1.3 N/mm and preferably between 2-5 N/mm.

The structure formed by removal facilitating film 4, compressible layer 5 and reinforcing layer 6 has a high tensile modulus in the rotation direction of the sleeve, but sufficient flexibility to deform in the nip. The high modulus value allows stressing of the compressible layer after slipping the sleeve on the printing cylinder and ensures both the maintaining of the sleeve during printing and the stability of the register in the printing nip. The flexibility makes it possible to transmit a deformation to the compressible layer and to regulate the width of the printing nip and the heterogeneities coming from overloads or lack of pressure at points in the transverse direction or in the rotation direction.

Printing layer 7 has a thickness less than 0.5 mm, and preferably between 0.2-0.4 mm.

The whole sleeve formed by the removal facilitating film, the compressible layer, the reinforcing layer and the printing layer can be disconnected by slipping the sleeve off with the compressed air of the tool tube. The total thickness of the sleeve is between 1.3 and 3 mm, a thickness of 2 mm +/−0.03 mm being particularly representative.

The whole can be produced in two steps or more. In the first case, in the first step, the sleeve is produced, and in the second step, the printing layer is produced. In the second case, all the elements of the sleeve and the printing layer are produced separately. The diameter of the hole, in the state in which it is not slipped on, is 0.1-0.5 mm less than the diameter of the support cylinder.

The solidarity under stress during printing between the sleeve and the support cylinder covered or not is ensured by the prestressing of all of the layers by means of the compressible layer or the reinforcing layer. It is possible to provide for an adjustment by combination of the internal diameter and the compressibility, the modulus, and the thickness of the compressible layer. The sleeve can be slipped on the support cylinder with the help of a cushion of air created between the sleeve and the cylinder.

The production of the actual printing layer will not be described here. For this purpose, processes, for example, as described in European patent EP 0 914 966 or in European patent EP 0 824 078 can be used. Concerning the production of the compressible layer and of the reinforcing layer, processes as described in European patent EP 0 452 184 and in European patent EP 0 631 884 can be used.

Concerning the functioning of the sleeve, the linear load applied in the nip must be between 3-6 N/mm and preferably between 3.3 and 4.7 N/mm for a penetration depth of 100 microns. The speed of use is between 100,000-120,000 revolutions per hour. The chemical resistance with regard to solvents and oily inks must guarantee a minimum of subsidence of the structure, maintaining of the cohesion while not bringing about delamination between the layers. For example, the peeling force must be maintained after immersion in a solution for 72 h at 50° C., in position of cyclic indentation (5 Hz) of 200 microns. The cohesion of the different layers between one another is preferably greater than 2 N/mm in terms of peeling force. The swelling or subsidence must remain less than 4% of the initial thickness, in contact with the chemical products. The subsidence during use must remain between 20 and 30 microns during pressing, in particular during the first 100,000 revolutions. The expected lifetime under normal conditions of use is 20-50 million revolutions.

1. A printing sleeve comprising a printing layer, a compressible layer, and a circumferential stiffening layer, wherein the stiffening layer is located between the compressible layer and printing layer.

2. The printing sleeve according to claim 1, including, on a radially internal surface of the compressible layer, a removal facilitating layer.

3. The sleeve according to claim 1, wherein the circumferential stiffening layer is a reinforcing layer on the compressible layer.

4. The printing sleeve according to claim 3, wherein the reinforcing layer has reinforcing elements in the form of one of fibers, wires, a knit, a fabric, and a screen in a matrix of a thermosetting or a thermoplastic polymer.

5. The printing sleeve according to claim 4, wherein the reinforcing elements have a single directional arrangement and are oriented generally circumferentially.

6. The printing sleeve according to claim 4, wherein the matrix is 20-80 wt % of the reinforcing layer, and the reinforcing elements are 80-20 wt % of the reinforcing layer.

7. The printing sleeve according to claim 4, wherein the reinforcing elements are selected from the group consisting of carbon, glass, high modulus polyester, and aramide.

8. The printing sleeve according to claim 3, wherein the reinforcing layer has a thickness between 0.2-0.5 mm.

9. The printing sleeve according to claim 3, wherein the reinforcing layer has a Young's modulus in the circumferential direction between 400-100,000 MPa.

10. The printing sleeve according to claim 4, wherein the matrix of the reinforcing layer has a Young's modulus between 50-1000 MPa.

11. The printing sleeve according to one of claim 4, wherein the reinforcing layer has an elongation at breakage in a circumferential direction of the reinforcing layer greater than 1.2%.

12. The printing sleeve according claim 4, wherein the reinforcing layer has a Young's modulus in a radial direction between 50-500 MPa.

13. The printing sleeve according to claim 4, wherein the reinforcing layer has a Young's modulus in a direction parallel to an axis of the reinforcing layer greater than 100 MPa.

14. The printing sleeve according to claim 2, wherein the compressible layer is an elastomer base containing microspheres and at least one expansion agent.

15. The printing sleeve according to claim 14, wherein the compressible layer includes one uniform layer or several superposed under-layers of different compressibilities.

16. The printing sleeve according to claim 14, wherein the compressible layer is produced by one of coating, spraying, and spray gunning of the elastomer base dissolved in a solvent.

17. The printing sleeve according to claim 14, wherein the elastomer base is an endless layer of a sheet rolled on itself or in a helicoidal strip.

18. The printing sleeve according to claim 14, wherein the compressible layer is molded and calibrated in thickness on a removal facilitating film.

19. The printing sleeve according to claim 14, wherein the compressible layer is molded and rectified after expansion.

20. The printing sleeve according to claim 2, wherein the removal facilitating layer is one of an elastomeric and plastic polymer.

21. The printing sleeve according to claim 2, wherein the removal facilitating layer is produced during the manufacturing of the sleeve by applying one of a gel coat a and paint on a peripheral surface after a removal facilitating agent has been applied.

22. The printing sleeve according to claim 2, wherein the removal facilitating layer is a heat-shrinkable tube.

23. The printing sleeve according to claim 2, wherein the removal facilitating layer is an electrostatically or thermally projected layer of a powder.

24. The printing sleeve according to claim 2, wherein the removal facilitating layer is sufficiently smooth to promote slipping of the sleeve off and on a support sleeve.

25. The printing sleeve according to claim 2, wherein the removal facilitating layer has a modulus of 5-800 MPa, a thickness of 0.02-0.1 mm, and a surface with an Ra factor less than 0.5 microns.

26. The printing sleeve according to claim 2, wherein the removal facilitating layer has a friction coefficient on steel or on composite resin between 0.2-0.5.

27. The printing sleeve according to claim 1, wherein the printing layer has a thickness less than 0.5 mm.
